(19) United States
(12) Patent Application Publication
(10) Pub. No.: US 2025/0320701 A1
(43) Pub. Date: Oct. 16, 2025

(54) SANITARY INSERT

(71) Applicant: NEOPERL GMBH, Müllheim (DE)

(72) Inventors: Sascha Horoba, Gottenheim (DE); David BIRMELIN, Müllheim (DE); Marc TEMPEL, Freiburg (DE); Georg STÄDTLER, Müllheim (DE)

(73) Assignee: NEOPERL GMBH, Müllheim (DE)

(21) Appl. No.: 18/869,924

(22) PCT Filed: May 30, 2023
(86) PCT No.: PCT/EP2023/064409

§ 371 Date: Nov. 27, 2024

(30) Foreign Application Priority Data
May 30, 2022 (DE) 20 2022 103 020.0
Nov. 25, 2022 (DE) 10 2022 131 224.0

(51) Int. Cl. E03C 1/086; E03C 1/02; E03C 1/084

(52) U.S. Cl. CPC E03C 1/086; E03C 1/084; E03C 2001/026

(57) ABSTRACT

In the case of a sanitary insert (1) that is designed to be installed on a water outlet (3) of a fitting (2), comprising a main body (4) and a movable actuation part (5) that makes contact with said main body, wherein the main body (4) has a switching mechanism (6), wherein the actuation part (5) can actuate the switching mechanism (6) by means of a control element (10), it is proposed that the actuation part (5) forms an abutment (12), preferably on an inwardly protruding projection (11), which abutment defines a pivot point (13) with respect to a lateral application of load, wherein an operative connection to the control element (10) is created which transforms the lateral application of load into an axial movement (FIG. 1).

### CROSS-REFERENCE TO RELATED APPLICATIONS

This application is a 371 National Phase of PCT/EP2023/064409, filed May 23, 2023, which claims priority from German Patent Application No. 20 2022 103 020.0, filed May 30, 2022, and German Patent Application No. 10 2022 131 224.0, filed Nov. 25, 2022, all of which are incorporated herein by reference as if fully set forth.

### TECHNICAL FIELD

The invention relates to a sanitary insert that is designed to be installed on a water outlet of a fitting, wherein the sanitary insert comprises a main body and a movable actuation part that makes contact with said main body, wherein the main body has a switching mechanism, wherein the actuation part can actuate the switching mechanism by means of a control element. A sanitary insert of this kind has many applications in practice.

The invention also relates to the use of a pivotable actuation part.

### BACKGROUND

Components of this kind are known and can be employed, for example, to switch between a low and a higher flow rate or between different jet shapes or in order to switch off or switch on a water jet.

Components of this kind are furthermore used to meet legal standards or specifications for fittings in respect of saving water.

Previously, it has been customary in the prior art to convert an axial actuating movement of the actuation part into an axial actuating movement of the switching mechanism or to convert a lateral actuating movement of the actuation part into an axial actuating movement of the switching mechanism.

WO 2020/164342 A1 discloses a sanitary insert which has an outlet structure that has a dome-like bulge. Here, in the case of a lateral application of load, the actuation part slides on a contact surface of the main body and displaces the bulge in relation to a control element. Here, however, one disadvantage of this solution is that a large amount of space is required and that the lateral application of load requires a relatively major exertion of force by the user. In sanitary arrangements involving restricted space conditions, actuation of the sanitary insert may therefore be difficult.

CN 107 289 184 A discloses a sanitary insert, wherein the outlet structure has a triangular shape into which a control element can be guided and moved. The lateral application of load to the actuation part is achieved by virtue of the fact that a radially encircling recess, into which the actuation part can be pushed, is formed on the main body. One disadvantage of this solution is that, once again, there is a large space requirement. This restricts the structural design possibilities of sanitary fittings to a considerable extent.

### SUMMARY

It is the underlying object of the invention to provide a sanitary insert which can eliminate the disadvantages of the prior art. In particular, the intention here is to provide a sanitary insert which is easy to operate and can be exchanged or serviced without tools, e.g. wrenches. Operability is improved, for example, by the fact that a user can simply screw the sanitary insert in and out by hand. The object is achieved by one or more of the features disclosed herein. Advantageous refinements are described below and in the claims.

It should be noted that the features presented individually herein can be combined in any technologically feasible manner and can define further refinements of the invention. Moreover, the features indicated in the claims are specified and explained in greater detail in the description, wherein further preferred refinements of the invention are presented.

In order to achieve the stated object, the invention proposes one or more of the features disclosed herein. In particular, the proposal according to the invention for achieving the stated object, in the case of a sanitary insert of the type described at the outset, is that the actuation part forms an abutment, which defines a pivot point with respect to a lateral application of load, wherein an operative connection to the control element is created which transforms the lateral application of load into an axial movement. This enables the sanitary insert to be used where the conditions associated with the fitting are restrictive or where there is little available space, and enables it to be actuated conveniently by the user.

In order to achieve the stated object, the invention furthermore proposes (alternatively or in addition) additional ones of the features disclosed herein directed to a sanitary insert of the type described at the outset in which the actuation part is connected to the control element via two mutually touching arched surfaces. Provision can be made, in a rest position, for the actuation part to be arranged coaxially with the main body and additionally or alternatively, in a or the rest position, for the actuation part to make contact with the control element at a point of a minimum force transmission ratio. Thus, the force transmission ratio or a force-displacement ratio can be set by means of the design of the two mutually touching arched surfaces. This can relate, for example, to the ratio of the two radii of curvature of the touching arched surfaces.

Here, a pivot point is a point around which a rotation of the actuation part takes place. This differs from a purely translational movement, e.g. an axial movement or a radial movement. This rotation is preferably a rotation about a horizontal axis or an axis which is transverse, in particular at right angles, to a flow direction of the insert.

In one advantageous refinement, provision can be made for a coupling function to be provided, which creates a connection for conjoint rotation between the actuation part and the main body. The actuation part and the main body can thus be connected to one another, and a user can screw the sanitary insert into and out of the fitting manually and without tools by means of a rotation. The coupling function is preferably active when the actuation part is actuated, in particular when the actuation part is raised or pivoted with respect to the main body.

In one advantageous refinement, provision can be made for the coupling function to be aligned with the switching mechanism. “Aligned” can mean that the switching mechanism and the coupling function act in the same direction and/or in opposite directions to one another. It is thus possible to double a functionality of the actuation part, it being possible here, in particular, to simply combine both the switching mechanism, which is relevant to the flow, and the coupling function, which is relevant to the installation and removal of the sanitary insert.

In one advantageous refinement, provision can be made for the coupling function to comprise a coupling element and a mating coupling element, which interact. In this way, the coupling function can be provided in a reliable and simple manner. It is also conceivable and possible for a plurality of coupling elements to be formed. It is also conceivable and possible for a plurality of mating coupling elements to be formed. The number of coupling elements and mating coupling elements can be determined during manufacture and, of course, affects the maximum angle by which it is necessary to perform a rotation to activate the coupling function. The coupling function is activated when the coupling element and the mating coupling element are in contact.

In one advantageous refinement, provision can be made for the coupling element to be formed on the actuation part. In this way, it is possible to provide a mechanically stable arrangement that is advantageous in terms of manufacture. As already explained above, it is also possible for a plurality of coupling elements to be formed on the actuation part.

In one advantageous refinement, provision can be made for the mating coupling element to be formed on the main body. It is thereby possible to provide a mechanically stable arrangement that is advantageous in terms of manufacture. As already explained above, it is also possible for a plurality of mating coupling elements to be formed on the main body. The mating coupling element or elements can be designed as a wall or a plurality of walls, for example. In general, a wall describes a structure which can separate two partial regions from one another.

In one advantageous refinement, provision can be made for the coupling element to have a deflection unit. In addition or as an alternative, provision can be made for the mating coupling element to have a mating deflection unit. This makes it possible, if the coupling element and the mating coupling element meet head-on, for these two parts to be guided smoothly past one another, and to simplify the coupling function overall. This is advantageous, for example, if the coupling element and the mating coupling element meet head-on and thus the coupling function cannot yet be activated.

In one advantageous refinement, provision can be made for the deflection unit and the mating deflection unit to be mirror-symmetrical. The axis of the mirror symmetry is preferably formed transversely, in particular orthogonally, to a flow direction. This enables the coupling element and the mating coupling element to be guided past one another in a manner that is efficient in terms of friction. “Mirror symmetry” can mean that a property, e.g. a geometrical property, of the deflection unit and of the mating deflection unit is mirror-symmetrical with the axis of the mirror symmetry. This can be advantageous in general for convenience of operation by the user.

In one advantageous refinement, provision can be made for the deflection unit to have at least one surface which is curved and/or planar. In addition or as an alternative, provision can be made for the mating deflection unit to have at least one other surface which is curved and/or planar. The deflection unit and the mating deflection unit can thus ensure that the coupling element and the mating coupling element can be guided past one another in a manner that is efficient in terms of friction. In particular, it is also possible here for handling by the user to be simplified overall since they do not have to expend a high force during this process to achieve the coupling function. The terms “planar” and “curved” are familiar from mathematics.

In one advantageous refinement, provision can be made for the control element to comprise a tappet and a spherical part. The tappet is preferably of cylindrical design. In this way, it is possible to provide a simple structural shape of the control element. The tappet and the spherical part can be formed integrally with one another, for example.

The tappet can be operatively connected to the switching mechanism, while the spherical part can be in constant contact with the actuation part and, in particular, an outlet structure.

In one advantageous refinement, provision can be made for a flow regulator to be arranged ahead of the main body on the upstream side. In this way, a function of the flow pressure versus the flow rate can be set or specified. This improves the operating properties of the sanitary insert.

In one advantageous refinement, provision can be made for a splitter unit to be arranged between the main body and the actuation part. The splitter unit is preferably arranged downstream of the switching mechanism. This makes it possible to achieve swirling of the water jet, which has an advantageous effect on the jet pattern.

In one advantageous refinement, provision can be made for the actuation element to have an outer sleeve. In addition, provision can be made for the actuation part to comprise an inner sleeve. Provision can be made for the outer sleeve and the inner sleeve to be connected to one another by webs and additionally or alternatively for aeration channels to be formed between the outer sleeve and the inner sleeve. In this way, a mechanically stable shape of the actuation part and/or admixture of air to the water jet can be achieved. This has an advantageous effect on the jet pattern.

The coupling element or the coupling elements is/are preferably formed on the inner sleeve. As an alternative or in addition, the coupling element or the coupling elements can be arranged on the outer sleeve.

In one advantageous refinement, provision can be made for the actuation part to be pivotable. This makes it possible to enhance the convenience of operation for a user and to reduce the space requirements for the sanitary insert. It is thus also a simple matter to direct an emerging water jet in different directions.

In one advantageous refinement, provision can be made for the splitter unit to have a channel in which the tappet lies in a leak-tight manner. In this way, a guiding device which can guide the tappet axially is provided.

In this invention, the term “axially” is used for the flow direction; in relation to this, “radially” is a direction which is formed orthogonally to the flow direction.

In one advantageous refinement, provision can be made for the inner sleeve to have an outlet structure. In this way, a uniform and visually appealing water jet can be provided.

In one advantageous refinement, provision can be made for the diameters of the tappet and of the spherical part to be different. In this way, a structural alternative can be provided. It is thus possible to provide a sliding surface which is not limited by the tappet.

In one advantageous refinement, provision can be made for the diameters of the tappet and of the spherical part to be the same or for the diameter of the tappet to be greater than the diameter of the spherical part. In this way, a structural alternative can be provided. It is thus also possible to insert the tappet by insertion into a guide opening, e.g. the already mentioned channel for axial guidance of the tappet, with the head part in the lead. This can make assembly easier.

In one advantageous refinement, provision can be made for the diameter of the tappet to be the same as an inside diameter of the channel. In this way, a guiding device can be provided. The tappet preferably lies leak-tightly against the channel.

The spherical part can be designed as a spherical segment, as a hemisphere or as a ball or as a segment of an ellipsoid, for example. Alternatively, the spherical part can be designed as a rounded portion. Even if there is no lower limit for the radii of curvature that can be used, it may be stated that sliding is in many cases all the better, the larger the radius of curvature is on the spherical part.

In one advantageous refinement, provision can be made for the outlet structure to have an arched surface. The arched surface is preferably of dish-shaped design. Provision can be made to enable the control element to slide on the arched surface. In this way, it is possible, in a manner that is simple in terms of design, to achieve an operative connection between the control element and the actuation part to which the outlet structure belongs.

In one advantageous refinement, provision can be made for the outlet structure to have a bulge, in particular wherein a width of the bulge is equal to a width of the outlet structure. The width of the outlet structure and the width of the bulge are measured in the flow direction. The bulge can be advantageous when actuating the actuation part, in particular when actuating the switching mechanism and the coupling function.

In one advantageous refinement, provision may be made for the switching mechanism to be a ballpoint mechanism or a pilot valve/main valve mechanism. Alternatively, it is also possible for the switching mechanism to be designed as a servo on-off mechanism or as a mechanism as known from WO 2018/050285 A1.

In one advantageous refinement, provision can be made for a force-displacement ratio of the control element to be a function of a deflection angle of the actuation part from a rest position. This enables the force-displacement ratio of the control element to be set by means of the deflection angle of the actuation part. This has a positive effect on the user-friendliness of the sanitary insert.

The “rest position” denotes the position of the sanitary insert in which the main body and the actuation part have coinciding main axes or are arranged coaxially.

In one advantageous refinement, provision can be made for an inwardly protruding projection, e.g. the already mentioned projection, to form a throat, in which a mating projection of the main body engages. In this way, the main body and the actuation part are connected to one another in a structurally simple manner.

In one advantageous refinement, provision can be made for the mating projection to be arranged between the inner sleeve and the outer sleeve. In this way, a mechanically stable arrangement is provided.

In one advantageous refinement, provision can be made for at least part of the inwardly protruding projection of the actuation part to be releasable from the outwardly protruding mating projection of the main body in the case of a lateral application of load to the actuation part. In this way, it is possible in a simple manner in terms of design to provide a pivot point and, overall, to provide an arrangement which is very suitable for use in restricted space conditions.

The present invention has recognized that the formation of a pivot point and the manner of actuation of the sanitary insert have a positive effect on the required employment of force or exertion of force by a user with respect to an existing water pressure.

In one advantageous refinement, provision can be made for part of the actuation part to touch the main body at a contact point in the case of a maximum lateral application of load to the actuation part. In this way, it is possible to provide a simple structural refinement of the main body and to limit and set a maximum lateral application of load.

In one advantageous refinement, provision can be made to enable the actuation part to both be subject to the lateral application of load and raised axially. This is achieved primarily through the shaping of the actuation part and of the control element. The characteristics of a lateral application of load and the possibility of axial raising are advantageous in respect of the user-friendliness of the sanitary insert.

In one advantageous refinement, provision can be made for the force-displacement ratio of the control element to be constant during axial raising of the actuation part. During axial raising, the actuation part is only raised axially, wherein the control element is likewise raised in a uniform manner, and can thus actuate the switching mechanism. The force-displacement ratio is thus constant and is achieved by means of the structural shape of the actuation part and of the control element. Axial raising of the actuation part by a certain distance is converted directly into the same axial distance of the control element.

In one advantageous refinement, provision can be made for centers of curvature of the two mutually touching arched surfaces to be situated within the control element. The two mutually touching arched surfaces are provided, on the one hand, by the arched surface (also referred to as mating surface) of the spherical part of the control element and, on the other hand, by the arched surface on the outlet structure of the actuation part. It is thus possible, by means of a simple design measure, to ensure that the control element can perform both an axial application of load and a lateral application of load.

It is advantageous here that a lateral application of load, which leads to a rotary movement of the actuation part about a pivot point, requires less exertion of force by the user than axial raising. This can enhance the convenience of operation of the sanitary insert.

In one advantageous refinement, provision can be made for the control element to be in operative connection with the switching mechanism. The switching mechanism can thus be switchable by the control element in a manner that is simple in terms of design.

In one advantageous refinement, provision can be made for the arched surface on the outlet structure to have through openings. In this way, a uniform water jet, which furthermore has an attractive jet pattern, can be provided.

Inter alia, the actuation part comprises the inner sleeve, which has the outlet structure. The inner sleeve furthermore has a mixing chamber, in which the water jet is mixed with air, wherein the air is drawn in via the aeration channels. The aeration channels are arranged between the inner sleeve and the outer sleeve.

In one advantageous refinement, provision can be made for the outlet structure to have, in the radial direction, through openings which have opening cross-sectional areas that increase toward the outside. In this way, it is possible to achieve a visually advantageous jet pattern and to provide an arrangement which delivers a uniform water jet.

In one advantageous refinement, provision can be made for the main body to have an external thread and additionally or alternatively an externally encircling sealing element. The sealing element is preferably designed as a sealing ring. In this way, the main body can be fastened to a sanitary fitting in a mechanically simple way and, in addition, can provide a sealing function which prevents water from flowing out between the sanitary fitting and the main body.

In one advantageous refinement, provision can be made for the force-displacement ratio of the control element to be a function of the deflection angle of the actuation part from a rest position, in particular wherein the function rises (preferably strictly) monotonically. In this way, the force-displacement ratio can be set by means of the arched surface (also referred to as mating surface) which is on the spherical part of the control element. In the case of a small deflection angle, the arched surface on the outlet structure is relatively flat, corresponding to a small force-displacement ratio. In the case of a larger deflection angle, the arched surface on the outlet structure has a steeper flank, corresponding to a larger force-displacement ratio. The force which is exerted on the switching mechanism by the control element thus increases with the deflection angle of the actuation part. This is advantageous for the user friendliness and quality of operation of the sanitary insert.

In one advantageous refinement, provision can be made for the actuation part to be attached to the main body by means of a snap connection. The snap connection is preferably of nondetachable design. It is thus possible to provide a simple structural and mechanically stable design which connects the actuation part and the main body to one another.

The main body has an outwardly protruding mating projection, on which the inwardly protruding projection of the actuation part engages. The main body furthermore has an encircling groove into which the inner sleeve of the actuation part projects in the case of a lateral application of load. The mating coupling element can be designed as a wall in the groove.

In one advantageous refinement, provision can be made for the snap connection to have run-on bevels and additionally or alternatively to have projections delimited in a circumferential direction. In this way, a lateral application of load and thus a rotation about a pivot point can be achieved. The run-on bevels can ensure that the inwardly protruding projection of the actuation part can be guided reliably past the main body in the case of a lateral application of load.

In order to achieve the stated object, one or more of the features disclosed herein which are directed to use, are provided according to the invention. In particular, the proposal according to the invention for achieving the stated object in the case of use is thus that a pivotable actuation part is designed for deflection of a laterally directed actuating force into an axially aligned actuating force for the actuation of a switching mechanism of a sanitary insert according to one of the abovementioned features. In this way, simplified actuation can be provided.

In order to achieve the stated object, one or more of the features disclosed herein directed to use of a pivotable actuation part configured to deflect a water jet emerging from a sanitary insert are provided. In this way, convenience of operation and quality of operation can be enhanced.

### BRIEF DESCRIPTION OF THE DRAWINGS

The invention will now be described in more detail on the basis of a few exemplary embodiments, but is not restricted to these exemplary embodiments. Further variants of the invention and exemplary embodiments arise from combining the features of individual claims or of a plurality of claims among themselves and/or with individual features or a plurality of features of the exemplary embodiments and/or the above-described variants of apparatuses and uses according to the invention.

In the figures:

FIG. 1 shows the sanitary insert in section in an initial position, and

FIG. 2 shows the sanitary insert in section in a home position with an inactive restrictor, and

FIG. 3 shows the sanitary insert in section in an axial actuated position, and

FIG. 4 shows the sanitary insert in section in a laterally actuated position, and

FIG. 5 shows the sanitary insert in section with an arbitrarily selected switching mechanism, and

FIG. 6 shows the sanitary insert in a perspective view from above, and

FIG. 7 shows the sanitary insert in a perspective view from below, and

FIG. 8 shows the actuation part in section, and

FIG. 9 shows an exemplary embodiment of a control element, and

FIG. 10 shows a further exemplary embodiment of a control element, and

FIG. 11 shows another exemplary embodiment of a control element, and

FIG. 12 shows a section through the control element from FIG. 11, and

FIG. 13 shows the sanitary insert in partial section in the initial position, and

FIG. 14 shows the sanitary insert from FIG. 13 in partial section in an actuated position, and

FIG. 15 shows the main body in an uninstalled state in perspective, and

FIG. 16 shows the actuation part in perspective, and

FIG. 17 shows the schematic diagram of the operation of the coupling function and of the deflection unit and of the mating deflection unit, and

FIG. 18 shows a section through the actuation part.

### DETAILED DESCRIPTION

In the following description of various exemplary embodiments of the invention, elements that correspond in terms of their function receive corresponding reference numerals, even in the case of a deviating design or shape.

In the figures, for the sake of clarity, not all the reference signs have been inserted even though the elements may very well be present in the figures. However, identical reference signs denote components and functional units that are functionally and/or structurally identical.

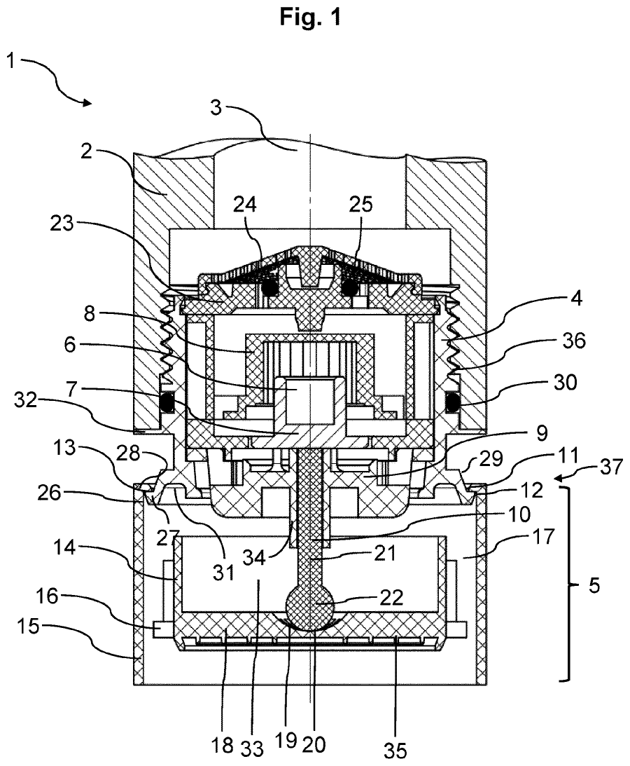

FIG. 1 shows the sanitary insert 1 in section in an initial position. The sanitary insert 1 is installed in a fitting 2, which has a water outlet 3. A flow direction is not illustrated graphically but runs from the top down.

The sanitary insert 1 comprises a main body 4 and an actuation part 5, which is arranged movably and makes contact with the main body 4.

The main body 4 has a switching mechanism 6, which is formed as a switching mechanism 6 with a restrictor 7 in the figure under consideration. Other switching mechanisms 6 may also be employed and used, e.g. a ballpoint mechanism or a pilot valve/main valve connection. The restrictor 7 has a hat-shaped protuberance, which consists of a cylindrical part and an encircling rim. The restrictor 7 can be introduced into a mating hat structure 8. In the present FIG. 1, the restrictor 7 is at an axial distance from the mating hat structure 8 and closes through openings belonging to a splitter unit 9.

The splitter unit 9 is arranged between the main body 4 and the actuation part 5.

The actuation part 5 can actuate and switch the switching mechanism 6 by means of a control element 10. In the figure under consideration, the control element 10 is in contact with the restrictor 7. The actuation part 5 has an inwardly protruding projection 11, in which an abutment 12 is formed. The projection 11 can run around the circumference or run around part of the circumference. The abutment 12 defines a pivot point 13 with respect to a lateral application of load, wherein an operative connection to the control element 10 is created. The control element 10 can transform a lateral application of load into an axial movement. The control element 10 is in operative connection with the switching mechanism 6.

The sanitary insert 1 provides a coupling function 37, which creates a connection for conjoint rotation between the actuation part 5 and the main body 4. The coupling function 37 can be activated and deactivated. Although the coupling function 37 is present in FIG. 1, it is not activated since both the main body 4 and the actuation part 5 are in the initial position. The coupling function 37 is aligned with the switching mechanism 6.

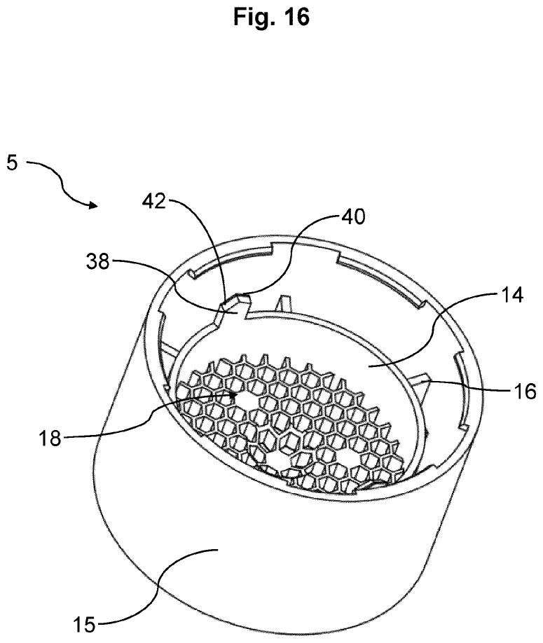

The coupling function 37 comprises a coupling element 38 (FIG. 16) and a mating coupling element 39 (FIG. 15), which interact. In FIG. 1, the coupling element 38 and the mating coupling element 39 are present but are not visible on account of the sectional illustration. The coupling element 38 is formed on the actuation part 5. The mating coupling element 39 is formed on the main body 4.

The actuation part 5 comprises an inner sleeve 14 and an outer sleeve 15, which are connected to one another by webs 16. On the inflow side, the inner sleeve 14 has a mixing chamber 33, in which a water jet can be mixed with air. The air is drawn in through aeration channels 17, which are situated between the inner sleeve 14 and the outer sleeve 15. On the outflow side, the inner sleeve 14 has an outlet structure 18. Centrally, the outlet structure 18 has an arched surface 19, in which the control element 10 is seated and can slide therein. The arched surface 19 is of dish-shaped design. The control element 10 has an arched mating surface 20, which touches the arched surface 19.

FIG. 1 shows a rest position or initial position, in which the actuation part 5 is arranged coaxially with the main body 4. In the rest position, the actuation part 5 makes contact with the control element 10 at a point of a minimum force transmission ratio.

The control element 10 comprises a tappet 21 and a spherical part 22. The tappet 21 is preferably of cylindrical design.

The tappet 21 is passed axially through a channel 34 and lies leak-tightly against the latter, wherein the channel 34 belongs to the splitter unit 9. The spherical part 22 is in constant contact with the arched surface 19, which belongs to the outlet structure 18.

A flow regulator 23 is arranged ahead of the main body 4 on the inflow side. The flow regulator 23 has a screen attachment 24, which is arranged ahead of the sealing element 25, e.g. a sealing ring, on the inflow side.

The inwardly protruding projection 11 forms a throat 26, in which a mating projection 27 of the main body 4 engages. The mating projection 27 is arranged radially between the inner sleeve 14 and the outer sleeve 15.

The centers of curvature of the two mutually touching arched surfaces 19, 20 are situated within the control element 10. By means of a technical design of the centers of curvature and of the radii of curvature of the arched surfaces 19, 20, it is possible to set force-displacement ratios and to improve the user-friendliness of the sanitary insert 1.

The actuation part 5 is attached to the main body 4 by means of a snap connection 28. The snap connection 28 is preferably of nondetachable design.

The snap connection 28 has run-on bevels 29 and mating projections 27 delimited in a circumferential direction.

The main body 4 has an external thread 36, by means of which it is screwed into the fitting 2. A sealing element 30 running around the outside ensures that no water can flow between the fitting 2 and the main body 4.

It may also be mentioned that the main body 4 has an encircling groove 31.

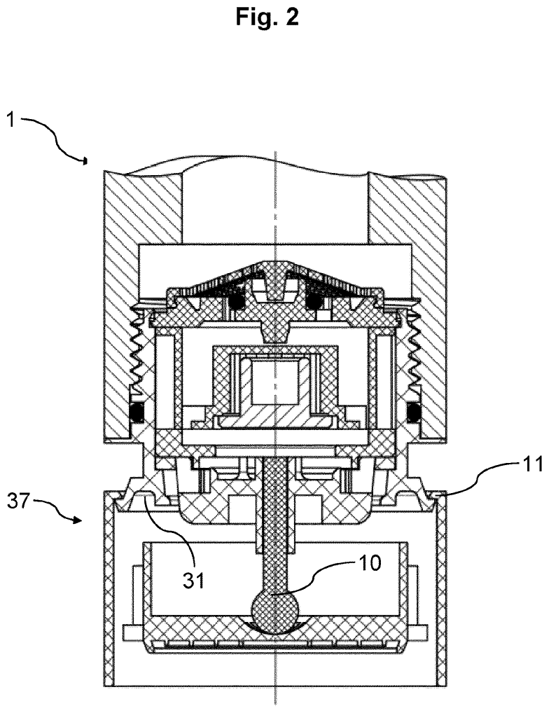

FIG. 2 shows the sanitary insert 1 in section in a home position with an inactive restrictor 7.

In FIG. 2 to FIG. 5, reference is made to the elements and the reference signs from FIG. 1. For greater clarity and to avoid redundancies, not all elements have been provided with reference signs in FIG. 2 to FIG. 5.

Here, the restrictor 7 has been introduced into the mating hat structure 8 and leaves the through openings of the splitter unit 9 free. On account of the prevailing water pressure, the restrictor 7 is pressed into the mating hat structure 8. When the water flow is switched off, the restrictor 7 can fall back into an original position (see FIG. 1) and block the through openings of the splitter unit 9. The elements in FIG. 2 correspond to the elements in FIG. 1 and are therefore not provided with reference signs.

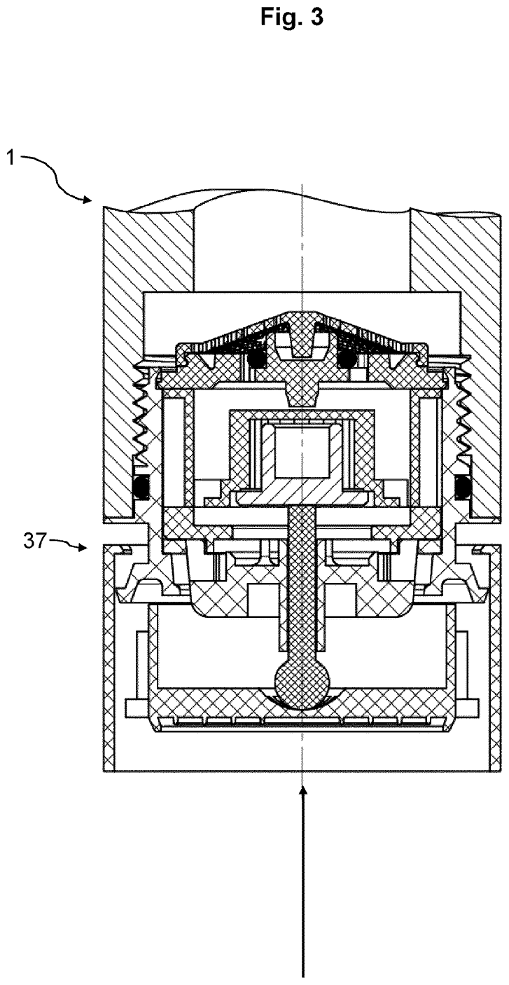

FIG. 3 shows the sanitary insert 1 in section in an axial actuated position. Here, the actuation part 5 has been raised axially relative to the main body 4, wherein the contact between the inwardly protruding projection 11 and the outwardly protruding mating projection 27 has been released. The actuation direction is indicated by an arrow.

In the case of axial actuation, the force-displacement ratio of the control element 10 is constant. This is achieved by the fact that the raising of the actuation part 5 is converted directly into raising of the control element 10. All that the user needs to do here is to exert a force which corresponds to the weight of the actuation part 5 and of the control element 10. The length of the tappet 21 must be dimensioned in such a way that the tappet 21 can be passed through the channel 34 and can insert the restrictor 7 into the mating hat structure 8.

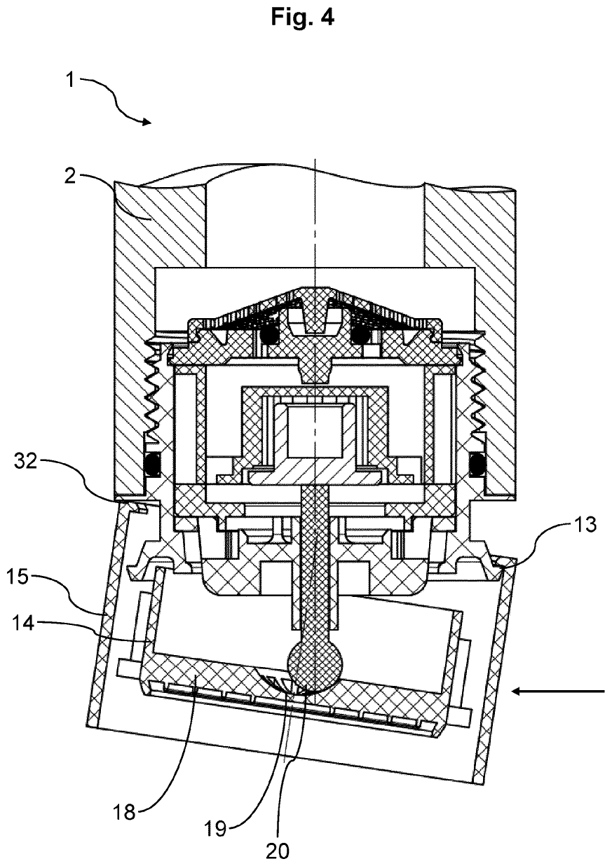

FIG. 4 shows the sanitary insert 1 in section in a laterally actuated position. A pivot point 13 is defined on the inwardly protruding projection 11, wherein the actuation part 5 and the main body 4 are arranged eccentrically. In this case, one part of the inner sleeve 14 protrudes into the encircling groove 31, while one part of the outer sleeve 15 touches the main body 4 at a contact point 32 in the case of a maximum lateral application of load to the actuation part 5. The dimensions of the control element 10 and of the arched surface 19 on the outlet structure 18 are matched in such a way that the restrictor 7 can be introduced into the mating hat structure 8. The force-displacement ratio of the control element 10 is a function of the deflection angle of the actuation part 5 out of a rest position, wherein the force-displacement ratio of the control element 10 rises in a strictly monotonic way in relation to the deflection angle of the actuation part out of the rest position. In the case of a small deflection angle out of the rest position, the force-displacement ratio is small, while, in the case of a larger deflection angle, it is likewise larger. It is advantageous here that the force-displacement ratios can be set through the choice or design of the arched surfaces 19, 20 and can enhance convenience of operation for the user.

The actuation direction is indicated by an arrow.

The lateral application of load to the actuation part 5 is advantageous particularly in restricted space conditions, and numerous different fittings 2 can be employed.

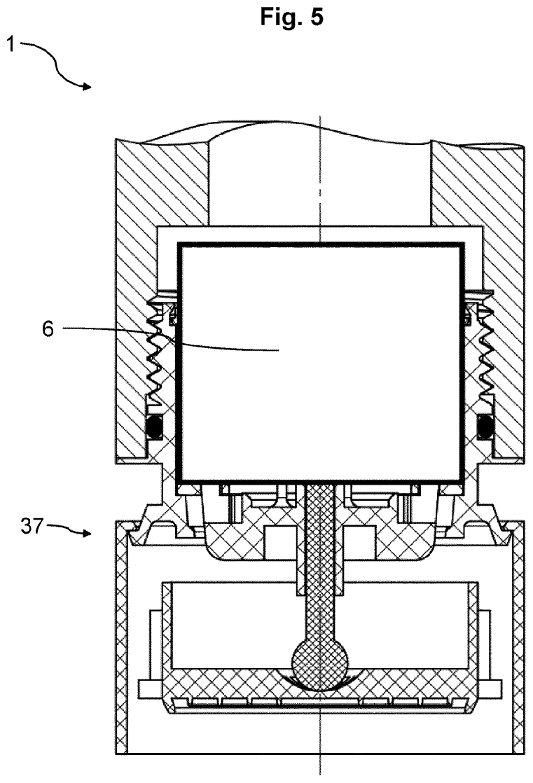

FIG. 5 shows the sanitary insert 1 in section with an arbitrarily selected switching mechanism 6. The switching mechanism can be, for example, a ballpoint mechanism or a pilot valve/main valve mechanism. As illustrated in the previous figures, the switching mechanism 6 may also be designed as a switching mechanism 6 with a restrictor 7. Other switching mechanisms 6 may also be employed in this context.

The sanitary insert 1 can be actuated both axially and laterally.

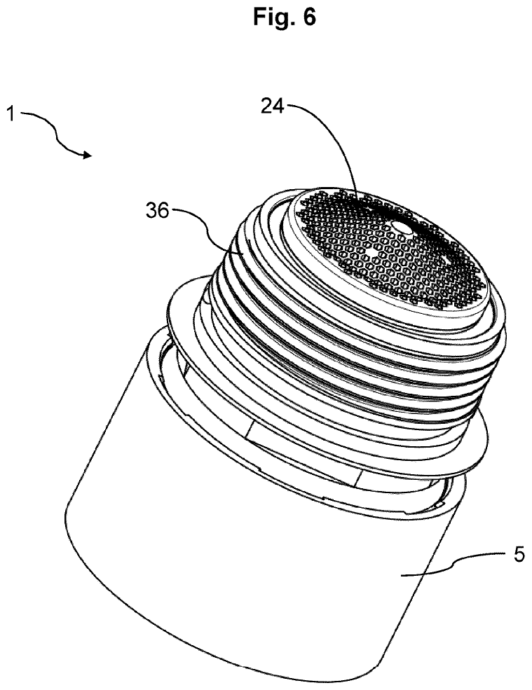

FIG. 6 shows the sanitary insert 1 in a perspective view from above. The screen attachment 24, the external thread 36 and the actuation part 5 are visible here.

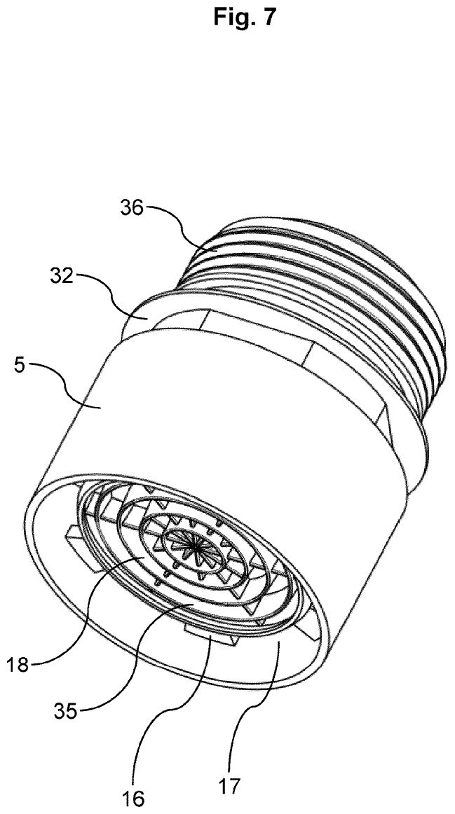

FIG. 7 shows the sanitary insert 1 in a perspective view from below. The external thread 36, the actuation part 5, the webs 16 and the outlet structure 18 are visible. In addition, FIG. 7 shows the contact point 32, which is formed on the main body 4.

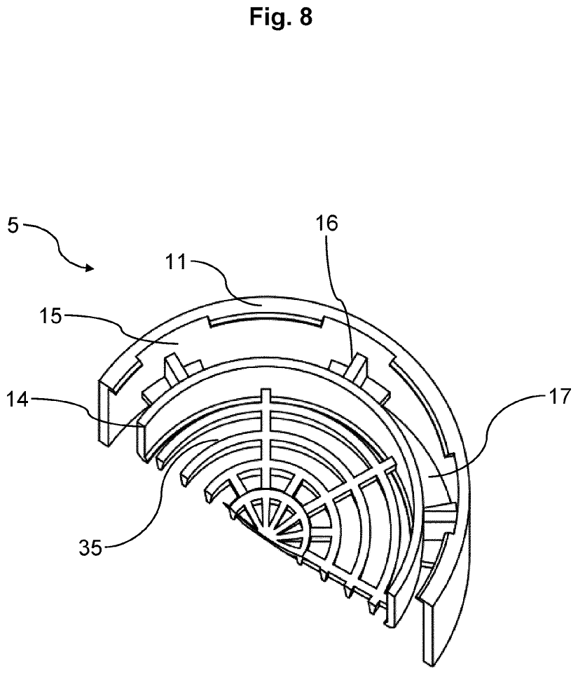

FIG. 8 shows the actuation part 5 in section. The inner sleeve 14 and the outer sleeve 15 are visible, wherein the two sleeves are connected to one another by webs 16. Aeration channels 17 are formed between the webs 16. The inwardly protruding projection 11 is designed to run around part of the circumference. The arched surface 19 on the outlet structure 18 has through openings. In addition, the outlet structure 18 generally has, in the radial direction, through openings 35, which have opening cross-sectional areas that increase toward the outside.

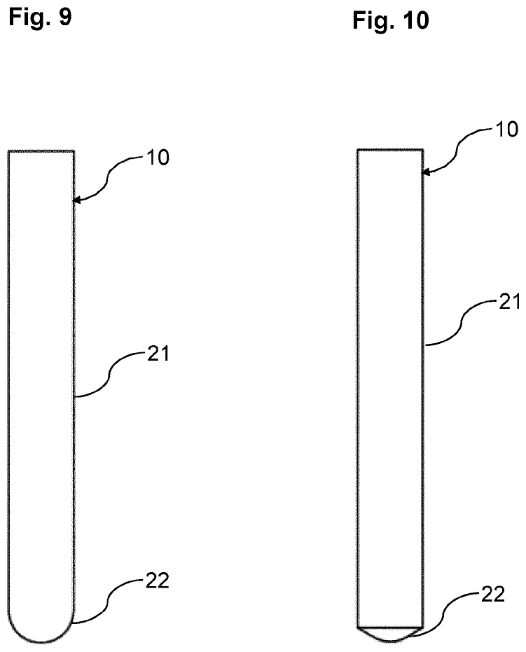

FIG. 9 shows an exemplary embodiment of a control element 10.

The control element 10 from FIG. 1 to FIG. 5 is constructed in such a way that a diameter of the tappet 21 is smaller than a diameter of the spherical part 22. The diameter of the tappet 21 is equal to an inside diameter of the channel 34 of the splitter unit 9. This has the effect that the direction of installation (e.g. during assembly) of the control element 10 must be from below, that is to say counter to the flow direction and counter to gravity. This can make assembly more difficult. For this reason, FIG. 9 to FIG. 12 show alternative embodiments of the control element 10.

The control element 10 from FIG. 9 has a preferably cylindrical tappet 21 and a spherical part 22, wherein the diameter of the tappet 21 is equal to the diameter of the spherical part 22. Here, the spherical part 22 is of hemispherical design. The diameter of the tappet 21 and of the spherical part 22 are matched to the inside diameter of the channel 34 and are equal to this inside diameter. Installation of the control element 10 in the sanitary insert 1 can therefore take place from above, that is to say in the flow direction and in the direction of gravity, and thus makes assembly easier. The tappet 21 and the spherical part 22 are of integral design.

FIG. 10 shows a further exemplary embodiment of the control element 10. The control element 10 again has a tappet 21 and a spherical part 22. Here, the spherical part 22 is designed as a rounded portion or as a spherical segment. The diameter of the rounded portion or of the spherical segment is identical to the diameter of the tappet 21. The diameter of the tappet 21 is matched to and equal to the inside diameter of the channel 34, which is part of the splitter unit 9. The tappet 21 can preferably be passed in a leak-tight manner through the channel 34. The tappet 21 and the spherical part 22 are of integral design.

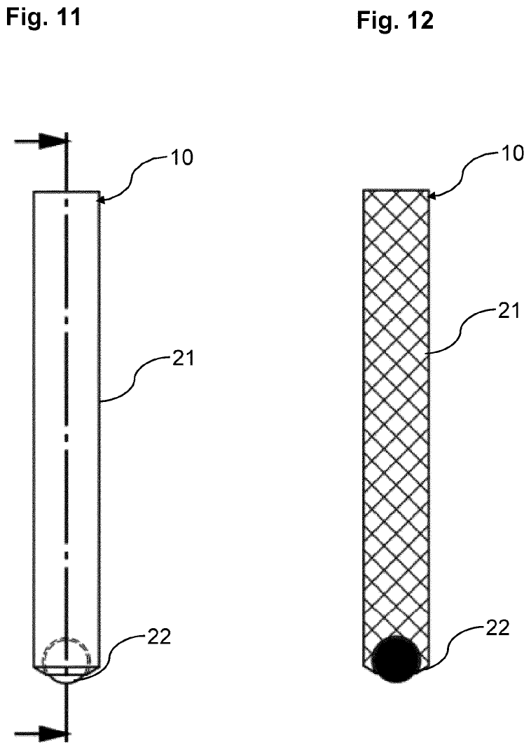

FIG. 11 shows another exemplary embodiment of the control element 10. The control element 10 has a tappet 21 and a spherical part 22. The tappet 21 and the spherical part 22 are of two-piece design, wherein the spherical part 22 is designed as a ball. The diameter of the spherical part 22 designed as a ball is smaller than the diameter of the tappet 21. The diameter of the tappet 21 is matched to and equal to the inside diameter of the channel 34. The ball can be rotated, like the ball in the tip of a ballpoint pen.

FIG. 12 shows a section through the control element 10 from FIG. 11. The spherical part 22, which is designed as a ball, is illustrated in solid black, while the tappet 21 is hatched.

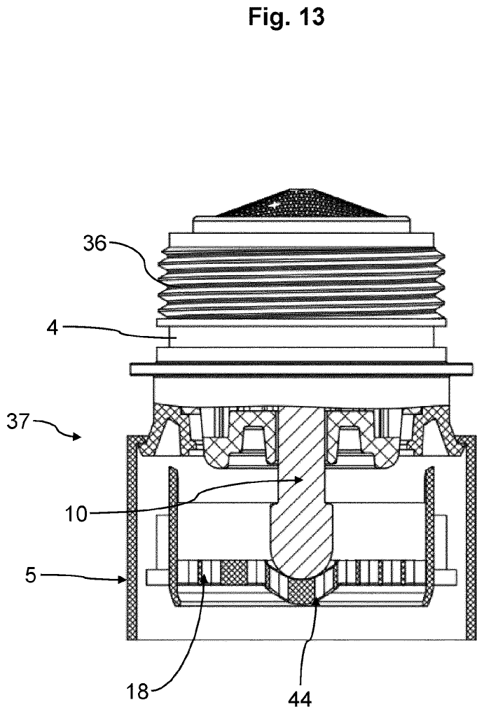

FIG. 13 shows the sanitary insert 1 in partial section in the initial position. The lower part of the sanitary insert 1 is shown in section, while the upper part is not sectioned and, inter alia, shows the external thread 36. In FIG. 13, the coupling function 37 is not activated, and therefore a user cannot screw the sanitary insert in and out in the initial position. The outlet structure 18 has a bulge 44, wherein a width 45 of the bulge 44 is equal to a width 46 of the outlet structure 18. The widths 45, 46 are measured in the flow direction.

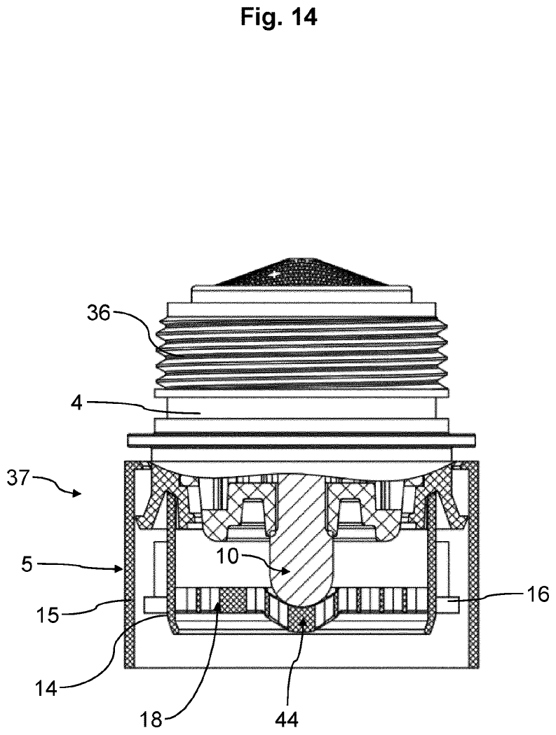

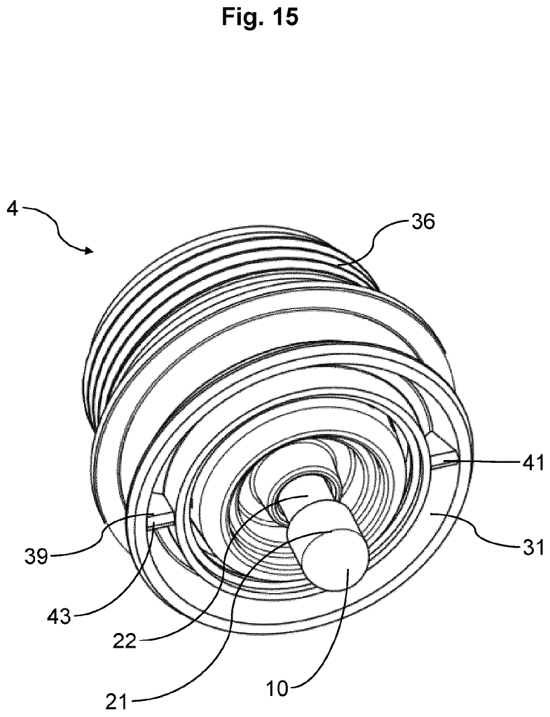

FIG. 14 shows the sanitary insert 1 from FIG. 13 in partial section in an actuated position. In the actuated position, the user has actuated the actuation part 5, with the result that the switching mechanism 6 is actuated, and the coupling function 37 is also activated.

FIG. 15 shows the main body 4 in an uninstalled state in perspective. The mating coupling element 39 is formed on the main body 4. The mating coupling element 39 is illustrated as a wall in the groove 31. The mating coupling element 39 has a mating deflection unit 41.

FIG. 16 shows the actuation part 5 in perspective. The coupling element 38 is formed on the actuation part 5. In FIG. 16, the coupling element 38 is formed on the inner sleeve 14. Of course, it is also possible for a plurality of coupling elements 38 to be formed in order, for example, to enhance the enjoyment of use of the user. The coupling element 38 has a deflection unit 40. The function of the deflection unit 40 is to deflect the coupling element 38 on the mating coupling element 39 (FIG. 15). This may be necessary, for example, if the coupling element 38 and the mating coupling element 39 meet head-on.

The function of the mating deflection unit 41 (FIG. 15) is to deflect the mating coupling element 39 (FIG. 15) on the coupling element 38.

In FIG. 15 in FIG. 16, the deflection unit 40 and the mating deflection unit 41 have planar surfaces 42, 43. In an alternative and additional embodiment, the surfaces 42, 43 can be curved. The shape of the surfaces may be correlated with the friction and the required expenditure of force by the user and may thus be relevant, in particular, for the convenience of operation by the user.

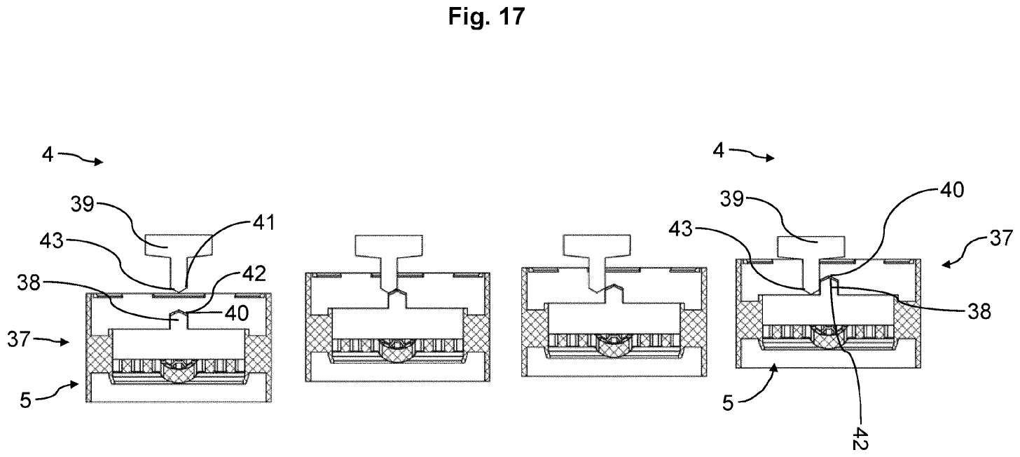

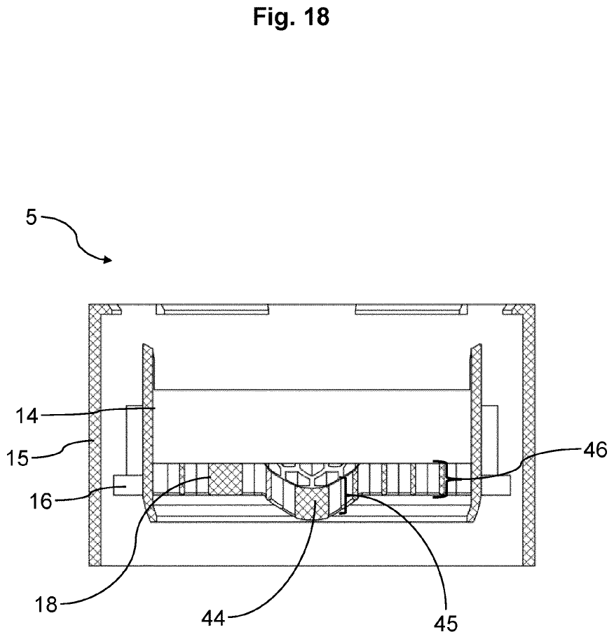

FIG. 17 shows a schematic diagram of the operation of the coupling function 37 and of the deflection unit 40 and of the mating deflection unit 41. Here, the actuation part 5 is actuated from left to right.

The first image from the left illustrates the initial position, in which, although the coupling function 37 is present, it is not active. The coupling element 38 and the mating coupling element 39 are visible and are at a distance from one another.

In the second image from the left, the coupling element 38 and the mating coupling element 39 meet one another since the user is actuating the actuation part 5. The deflection unit 40, which is formed on the coupling element 38, and the mating deflection unit 41, which is formed on the mating coupling element 39, act against one another and prevent the coupling element 38 and the mating coupling element 39 from meeting head-on.

In the third image from the left, the coupling element 38 and the mating coupling element 39 have been moved past one another completely. During the deflection between the first image from the left and the third image from the left, a slight relative rotation takes place between the main body 4 and the actuation part 5.

In the fourth image from the left, an end position has now been reached, in which the coupling function 37 has been activated. By rotating the actuation part 5, which is now connected to the main body 4 for conjoint rotation therewith, the user can now rotate the sanitary insert 1 out of the fitting 2 and back into it again. This may be advantageous for servicing the sanitary insert 1 or exchanging the sanitary insert 1.

The deflection unit 40 and the mating deflection unit 41 are mirror-symmetrical. This can mean that the deflection unit 40 and the mating deflection unit 41 are mirror-symmetrical with respect to an axis.

In the case of a sanitary insert 1 that is designed to be installed on a water outlet 3 of a fitting 2, comprising a main body 4 and a movable actuation part 5 that makes contact with said main body, wherein the main body 4 has a switching mechanism 6, wherein the actuation part 5 can actuate the switching mechanism 6 by means of a control element 10, it is proposed that the actuation part 5 preferably forms an abutment 12 on an inwardly protruding projection 11, which abutment defines a pivot point 13 with respect to a lateral application of load, wherein an operative connection to the control element 10 is created which transforms the lateral application of load into an axial movement.

### LIST OF REFERENCE SIGNS

1 Sanitary insert
2 Fitting
3 Water outlet
4 Main body
5 Actuation part
6 Switching mechanism
7 Restrictor
8 Mating hat structure
9 Splitter unit
10 Control element
11 Projection
12 Abutment
13 Pivot point
14 Inner sleeve
15 Outer sleeve
16 Webs
17 Aeration channels
18 Outlet structure
19 Arched surface
20 Arched mating surface
21 Tappet
22 Spherical part
23 Flow regulator
24 Screen attachment
25 Sealing element
26 Throat
27 Mating projection
28 Snap connection
29 Run-on bevel, run-on bevels
30 (Other) sealing element
31 Groove
32 Contact point
33 Mixing chamber
34 Channel
35 Through openings
36 External thread
37 Coupling function
38 Coupling element
39 Mating coupling element
40 Deflection unit
41 Mating deflection unit
42 Surface on 40
43 Surface on 41
44 Bulge
45 Width (of 44)
46 Width (of 18)

1. A sanitary insert (1) that is designed to be installed on a water outlet (3) of a fitting (2), the sanitary insert comprising:
a main body (4); a movable actuation part (5) that makes contact with said main body; the main body (4) has a switching mechanism (6), and the actuation part (5) is adapted to actuate the switching mechanism (6) via by means of a control element (10); and
the actuation part (5) forms an abutment (12) that defines a pivot point (13) with respect to a lateral application of load, and an operative connection to the control element (10) is created which transforms the lateral application of load into an axial movement.

2. The sanitary insert (1) according to claim 1, wherein the actuation part (5) is connected to the control element (10) via two mutually touching arched surfaces (19, 20), and at least one of a) in a rest position, the actuation part (5) is arranged coaxially with the main body (4), or b) in a rest position, the actuation part (5) makes contact with the control element (10) at a point of a minimum force transmission ratio.

3. The sanitary insert (1) as claimed in claim 1, wherein the control element (10) comprises a tappet (21) and a spherical part (22).

4. The sanitary insert (1) as claimed in claim 1, further comprising a flow regulator (23) arranged ahead of the main body (4) on an upstream side.

5. The sanitary insert (1) as claimed in claim 1, further comprising a splitter unit (9) is arranged between the main body (4) and the actuation part (5).

6. The sanitary insert (1) as claimed in claim 1, further comprising at least a coupling element formed on the main body (4), or in that a mating coupling element is formed on the actuation part (5).

7. The sanitary insert (1) as claimed in claim 6, further comprising an insertion aid formed on at least one of the coupling element or on the mating coupling element.

8. The sanitary insert (1) as claimed in claim 6, wherein the coupling element and the mating coupling element are adapted to be connected to one another by actuation of the main body (4).

9. The sanitary insert (1) as claimed in claim 6, wherein at least one of the coupling element or the mating coupling element have recesses.

10. The sanitary insert (1) as claimed in claim 9, wherein the coupling element and the mating coupling element are designed such that the actuation part (5) is tiltable.

11. The sanitary insert (1) as claimed in claim 9, wherein the recesses of the at least one of the coupling element or of the mating coupling element widen radially.

12. The sanitary insert (1) as claimed in claim 1, wherein the actuation part (5) has an outer sleeve (15), and comprises an inner sleeve (14), in particular wherein and at least one of a) the outer sleeve (15) and the inner sleeve (14) are connected to one another by webs (16), or b) aeration channels (17) are formed between the outer sleeve (15) and the inner sleeve (14).

13. The sanitary insert (1) as claimed in claim 1, wherein the actuation part (5) is pivotable.

14. The sanitary insert (1) as claimed in claim 5, wherein the control element (10) comprises a tappet (21) and a spherical part (22), and the splitter unit (9) has a channel (34) in which the tappet (21) lies in a leak-tight manner.

15. The sanitary insert (1) as claimed in claim 14, wherein diameters of the tappet (21) and of the spherical part (22) are different.

16. The sanitary insert (1) as claimed in claim 14, wherein diameters of the tappet (21) and of the spherical part (22) are the same.

17. The sanitary insert (1) as claimed in claim 14, wherein a diameter of the tappet (21) is the same as an inside diameter of the channel (34).

18. The sanitary insert (1) as claimed in claim 12, wherein inner sleeve (14) has an outlet structure (18).

19. The sanitary insert (1) as claimed in claim 18, wherein the outlet structure (18) has an arched surface (19).

20. The sanitary insert (1) as claimed in claim 1, wherein the switching mechanism (6) has a ballpoint mechanism or a pilot valve/main valve mechanism.

21. The sanitary insert (1) as claimed in claim 1, wherein a force-displacement ratio of the control element (10) is a function of a deflection angle of the actuation part (5) from a rest position.

22. The sanitary insert (1) as claimed in claim 1, wherein the abutment (12) comprises an inwardly protruding projection (11) that forms a throat (26), in which a mating projection (27) of the main body (4) engages.

23. The sanitary insert (1) as claimed in claim 22, wherein the actuation part (5) has an outer sleeve (15), and comprises an inner sleeve (14), and at least one of a) the outer sleeve (15) and the inner sleeve (14) are connected to one another by webs (16), or b) aeration channels (17) are formed between the outer sleeve (15) and the inner sleeve (14), and the mating projection (27) is arranged radially between the inner sleeve (14) and the outer sleeve (15).

24. The sanitary insert (1) as claimed in claim 23, wherein at least part of the inwardly protruding projection (11) of the actuation part (5) is releasable from the outwardly protruding mating projection (27) of the main body (4) upon a lateral application of load to the actuation part (5).

25. The sanitary insert (1) as claimed in claim 1, wherein part of the actuation part (5) touches the main body (4) at a contact point (32) upon a maximum lateral application of load to the actuation part (5).

26. The sanitary insert (1) as claimed in claim 1, wherein the actuation part (5) is adapted to both be subject to lateral application of load and raised axially.

27. The sanitary insert (1) as claimed in claim 26, wherein a force-displacement ratio of the control element (10) is constant during axial raising of the actuation part (5).

28. The sanitary insert (1) as claimed in claim 19, wherein control element (10) has an arched mating surface (20), which touches the arched surface (19), and one of the preceding claims, characterized in that centers of curvature of the two mutually touching arched surfaces (19, 20) are situated within the control element (10).

29. The sanitary insert (1) as claimed in claim 28, wherein the control element (10) is in operative connection with the switching mechanism (6).

30. The sanitary insert (1) as claimed in claim 28, wherein the arched surface (19) on the outlet structure (18) has through openings (35).

31. The sanitary insert (1) as claimed in claim 28, wherein the outlet structure (18) has, in a radial direction, through openings (35) which have opening cross-sectional areas that increase toward outside.

32. The sanitary insert (1) as claimed in claim 1, wherein the main body (4) has at least one of an external thread (36) or an externally encircling sealing element (30).

33. The sanitary insert (1) as claimed in claim 1, wherein a force-displacement ratio of the control element (10) is a function of a deflection angle of the actuation part (5) from a rest position.

34. The sanitary insert (1) as claimed in claim 1, wherein the actuation part (5) is attached to the main body (4) by snap connection (28).

35. The sanitary insert (1) as claimed in claim 34, wherein the snap connection (28) has at least one of run-on bevels (29) or projections (11) delimited in a circumferential direction.

36. (canceled)

37. (canceled)
